(19) United States
(12) Patent Application Publication
(10) Pub. No.: US 2011/0258299 A1
(43) Pub. Date: Oct. 20, 2011

(54) SYNCHRONIZATION OF CONFIGURATIONS FOR DISPLAY SYSTEMS

(75) Inventors: Gregory Charles Herlein, San Francisco, CA (US); Robert Boyd, San Bruno, CA (US)

(73) Assignee: THOMSON LICENSING

(21) Appl. No.: 12/998,987

(22) PCT Filed: Dec. 30, 2008
(86) PCT No.: PCT/US2008/014098

§ 371 Date: Jun. 21, 2011

(51) Int. Cl. G06F 15/177

(52) U.S. Cl. 709/221

(57) ABSTRACT

A method and system for synchronizing configurations of a video display system are disclosed. Configuration information at a facility server and that stored at a central server are synchronized using a procedure that depends on a relationship of the central server and the facility server, or an operating state of the facility.

### TECHNICAL FIELD

This invention relates to a method and system for synchronizing configurations of display systems.

### BACKGROUND

In-store media content distribution has become increasingly popular for in-store retail advertising. In such systems, content is distributed by a server and received by many receivers, e.g., set-top-boxes, for distribution to respective displays and associated speakers. However, provisioning and managing the configuration of many thousands of remotely located video advertising systems is very costly. A change to the configuration is often needed on one or more systems. When changes are performed on a system in the store, the configuration needs to be archived centrally for re-application in the case of server replacement. These changes may also need to be replicated across many other servers. Furthermore, once a system has been properly configured, it is useful to know if the configuration has been changed locally without central authorization. Thus, there is a need for improved method for configuration management.

### BRIEF SUMMARY OF THE INVENTION

Embodiments of the present invention provide a method and system for synchronizing configurations of video display systems, e.g., by synchronizing configuration information between a server at one facility or location and another server at a different location or facility.

One embodiment provides a method, which includes: ascertaining whether a first configuration information from a first server at a facility is different from a second configuration information from a second server, and if so, synchronizing the first configuration information and the second configuration information based on at least one of: a state of the facility, and a relationship between the first server and the second server. The first configuration information and the second configuration information relate to configuration of at least one device at the facility.

Another embodiment relates to a system, which includes a first server connected to at least one device at a facility, a second server at a location different from the facility. The second server is configured for synchronizing a first configuration information on the first server and a second configuration information on the second server based on one of: a state of the facility, and a relationship between the first server and the second server. The first configuration information and the second configuration information include information relating to the at least one device.

### BRIEF DESCRIPTION OF THE DRAWING

The teachings of the present invention can be readily understood by considering the following detailed description in conjunction with the accompanying drawings, in which:

FIG. 1 illustrates a network system for implementing embodiments of the present principles;

FIG. 2 illustrates a method of checking the configuration information of a facility server;

FIG. 3 illustrates a method of synchronizing configuration files between a central server and a facility server according to one embodiment; and

FIG. 4 illustrates a method of synchronizing configuration files between a central server and a facility server according to another embodiment.

To facilitate understanding, identical reference numerals have been used, where possible, to designate identical elements that are common to the figures.

### DETAILED DESCRIPTION

Embodiments of the invention provide a method and system for synchronizing configuration information between at least one server at a facility and a central server serving more than one facilities. The central server may be at a different location from the facilities. The method involves collecting data over a network from at least one server in a facility or location, and comparing configuration information received from that server (also referred to as a facility server) with reference configuration information that has been stored or archived in the central server.

If there is a mismatch between the configuration information from the facility server and that stored at the central server, one or more action will be undertaken, which may include, for example, forcing the facility server to match the central server, or the central server to match the facility server, or noting the difference and providing a message to appropriate entity or personnel for further action. Depending on the status of the facility or location, or a relationship between the facility server and the central server, different procedures are used for achieving configuration synchronization (i.e., keeping the configuration information at the facility server to be the same as that stored on the central server). By setting the synchronization action in accordance with one or more predetermined rules, the need for human or manual intervention can be reduced.

Embodiments of the invention can be applied to many different facilities, including a variety of establishments or installations, public or private venues. In one embodiment, the facility is a business establishment having a server for managing and delivering data or content to display equipment or terminals in the business establishment. In another embodiment, the facility is an establishment related to the distribution, storage, and/or sale of goods or services, e.g., warehouse, showrooms, shops, department stores, and so on. In yet another embodiment, the facility is a store with a server for managing and delivering content for retail advertising.

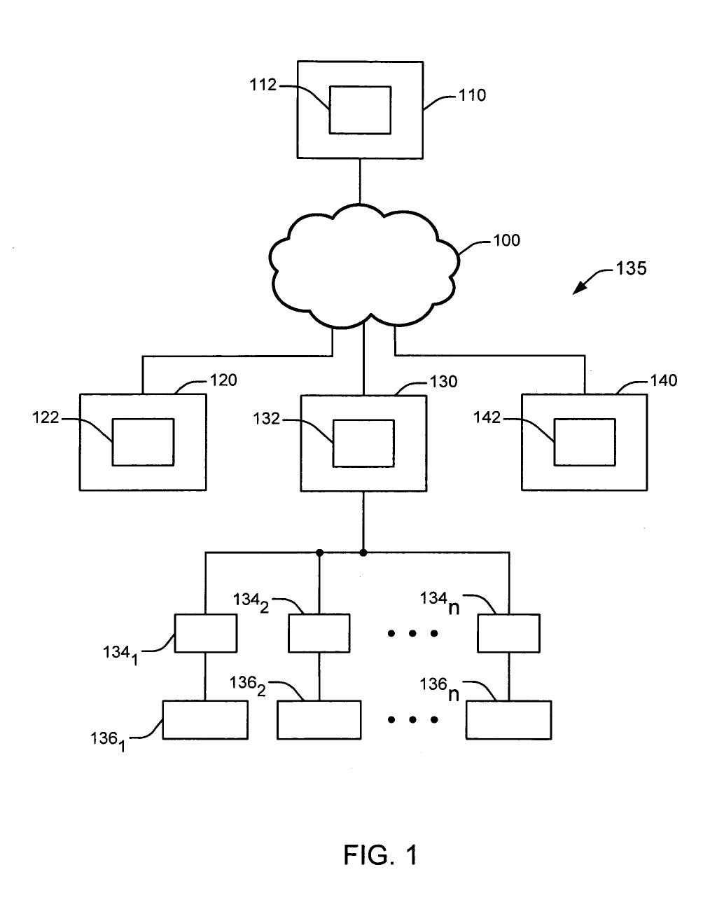

FIG. 1 is a schematic diagram of a network suitable for implementing one or more embodiments of the present principles. As shown in FIG. 1, at least one server 110, also referred to as a configuration server or central server, is connected to many servers, e.g., representative servers 120, 130, 140, which are distributed across a network 100. In one embodiment, the central server is connected via the internet or a wide area network (WAN) to servers 120, 130, 140 in different facilities, and a network management software 112 is provided on the central server 110 for managing various tasks on the network. In one example, the WAN is a retailer's network, and the network management software is the Retail Network Manager (RNM) from Premier Retail Networks, San Francisco, Calif.

Each server 120, 130, 140 includes a respective video network manager (VNM) 122, 132, 142, which is a software application for managing the delivery of digital content to one or more video playout or display units in respective facilities in the network. Displays 136₁, 136₂, . . . , and 136ₙ are shown as representative devices in video display system 135, which also includes facility server 130, and one or more receivers 134₁, 134₂, . . . , and 134ₙ (e.g., set-top boxes) associated with the video display units. In the example of a retailer's network, the video display system 135 may be an in-store advertising system.

To ascertain the configuration status of respective facility servers 120, 130, 140, or to ensure that configuration information on facility servers matches corresponding information stored or archived on the central server 110, data from the facility servers 120, 130, 140 is collected by the central server 110 on a regular or periodic basis. Such data may include information relating to health status, play logs, content state, custom configuration files for various devices and components in a facility, and information such as audio profiles, device group configuration, channel maps, and so on. In one embodiment of the invention, configuration data includes files that map specific video devices (such as set top boxes, network audio processors, and screens) to channels of operation. A channel is a logical collection of devices configured to play back a single video stream. In such an embodiment, other configuration data includes default volume levels, audio frequency equalization profiles, and default video stream information to display on startup.

In one embodiment, a configuration management system (CMS) on the central server 110, e.g., provided as a component of the network management application software 112, serves as a centralized mechanism for data collection and backup of configuration-related files for servers at retail locations. Configuration synchronization is performed based on the collected information, and may be incorporated into the backup operation.

Data collection and backup for all managed sites can be scheduled on a regular or periodic basis, which is configurable on the central server 110. In one embodiment, the backup for each site is done on a daily basis.

To better manage disk space utilization, a configurable setting may be provided for controlling the number of backups (each backup includes a number of archived files) kept on the central server 110. In one embodiment, archive files are stored at the central server 110 with a sub-directory for each facility site or location. Within each facility sub-directory, the latest versions of all archived files for a facility are stored in a latest archive directory, and optionally, a configurable number of date-time stamped archives of earlier versions may also be stored. The latest archive directory contains a snapshot of all the files under management, which represents a complete configuration for the facility site valid from the time of the previous archive to the current date-time stamped moment.

To begin data collection and/or configuration status check of facility servers, a connection is initiated by the network manager software (e.g., Retail Network Management in the case of a retails network) 112 on the central server 110 to a facility server, e.g., by interfacing with the video network manager (VNM) of the facility server. In one embodiment, a list of desired files for a given facility site is loaded from an XML file specification on the central server 110, and an interface on the VNM (e.g., VNM 122, 132 or 142) provides for checking configuration information or files on the facility server.

Configuration of the video display system 135 is done using a number of XML-based configuration files. In this embodiment, files are used in preference to other methods (e.g., database or Windows™ registry settings) for several reasons. For example, not only can a file-based approach facilitate distribution of new settings over multicast file transfer network links and support across different platforms and/or computer languages, it is also not affected or limited by technologies used by different retail locations, e.g., operating systems or database technologies used by different retailers. Furthermore, the XML-based files, which are human readable, can be understood readily by humans and computer systems alike. In addition, mathematical hash calculations can also be performed readily between two XML files for identifying differences between the files, which facilitates the synchronization of configuration files according to present principles. However, the invention is not limited to using XML files. Any configuration data format can also be used by this invention.

The collected configuration information, i.e., actual configuration information at a facility server, e.g., server 120, is compared to reference configuration information for that facility server, which has been stored on the server 110 or on a memory device associated with the server 110. This comparison is done in the Retail Network Manager.

In one embodiment, the collected configuration information and the reference configuration information are provided in the form of XML files, and alternatively, as hash values corresponding to the configuration information or files. For example, a hash function such as a Message-Digest algorithm 5 (MD5) can be used to process a configuration file to generate a MD5 hash value or checksum (in the form of a fixed-size bit string) for the file. By comparing the hash values of two configuration files, one can obtain an indication as to whether the files are different, because a relatively small change in a file results in a very different checksum. Changes in a file, or in a set of files or file directories can be easily detected by comparing the corresponding checksums for the original file(s) and the current file(s).

For example, a file script on a VNM interface can be used to generate an MD5 sum for a configuration file for a facility, i.e., the MD5 sum corresponding to the actual configuration file at the facility server. This MD5 sum from the facility server is compared to the latest archived MD5 sum (for that facility) on the central server, also referred to as a reference MD5 sum.

By comparing the corresponding MD5 sums, one can determine relatively quickly whether the file at the facility is different from the archived version at the central server.

In one embodiment, an XML file is provided on the central server 110 in the latest archive directory for storing all the MD5 sum for the configuration files. To conserve bandwidth, files that are the same as the latest archived ones on the central server 110 will not be transferred from the facility site to the central server 110.

Thus, if the actual MD5 sum and the reference MD5 sum match each other (i.e., the configuration information at the facility server is the same as that stored on the central server), no backup or file transfer is needed. Instead, the time of this configuration check can be noted, e.g., by the network management software, and the central server 110 can proceed to check configurations of other facilities.

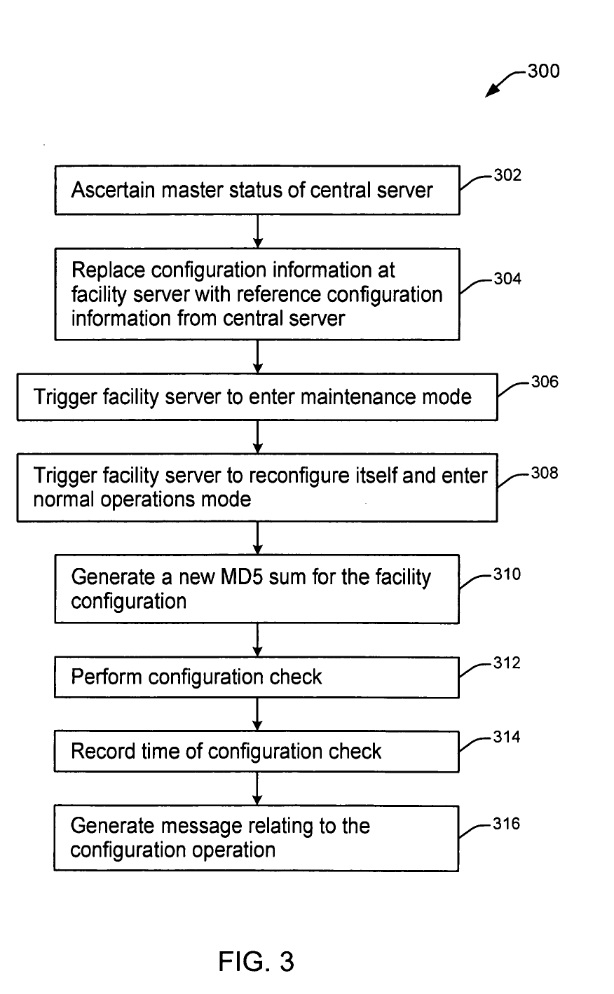

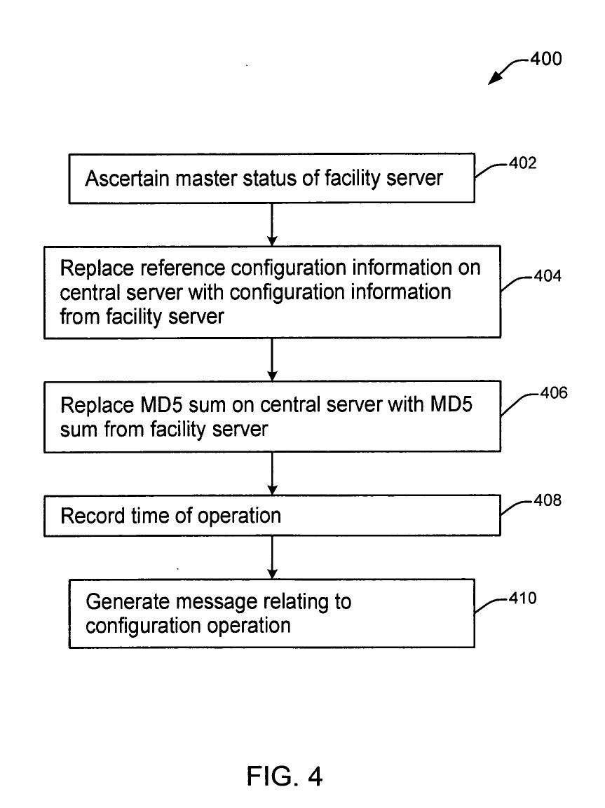

However, if the actual MD5 sum for the facility is different from the reference MD5 sum stored on the central server, then the network management software will perform a configuration synchronization operation for that facility based on certain predetermined rules or criteria. Configuration synchronization procedures will be discussed below in connection with FIG. 3 and FIG. 4.

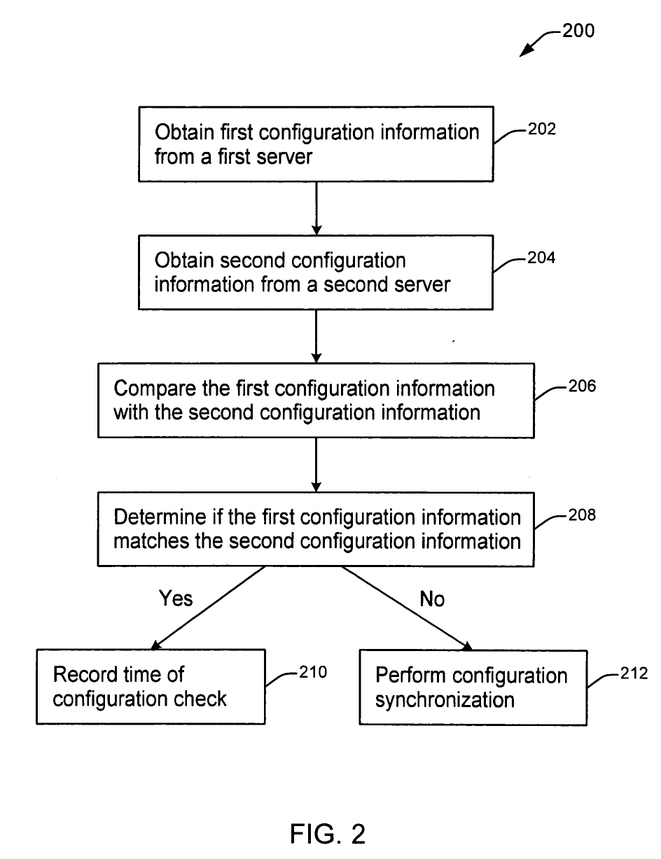

FIG. 2 illustrates a method 200 for performing a configuration check of a facility server. In step 202, configuration information at a particular facility (i.e., actual configuration) is retrieved from the facility server. This can be done, for example, by the network management software connecting to the VNM via a REST API (representational state transfer application programming interface). The advantage of using REST API lies in its simplicity compared to other approaches, although alternative interfaces can also be used, if desired.

The REST API can be used for performing a variety of tasks, including, for example, retrieving summary data and MD5 sum for the entire configuration tree or similar information for any specific configuration file. The entire configuration tree means the set of all folders that contain configuration files as well as the configuration files themselves. Such information is stored in various files by the VNM on the facility server. In addition, the REST API can retrieve the value of any configuration element from any specific configuration file, push new configuration files to the VNM or facility server (from the central server), pull configuration files from the VNM or facility server (to the central server), or restart the video display system, including reconfiguring it via the configuration manager system on the central server 110.

In one embodiment, the information in step 202 is provided as a MD5 sum for the entire configuration tree, also referred to as “MD5actual”. In step 204, the network management software retrieves the configuration information for the VNM, e.g., the MD5 of the entire configuration tree, that was last stored in a database or in a memory associated with the server 110 (referred to as the “MD5reference”).

In step 206, the configuration information from the facility (e.g., MD5actual) and the information stored in the central server (e.g., MD5reference) are compared. A determination is then made as to whether the configuration information from both servers are the same, as shown in step 208. If the answer is “yes”, the method proceeds to step 210, and the time of this configuration check is recorded, e.g., in the database associated with the central server 110. If there are other facilities in the network requiring configuration checks, the network management software can repeat the procedure starting from step 202.

On the other hand, if there is a mismatch between the configuration information from the facility and central servers, the network management software will perform a configuration synchronization operation on that facility, as shown in step 212.

The procedure for configuration synchronization varies according to the status of the servers, or a relationship between central server 110 and the specific facility server, e.g., which server is considered the “master”, and which is considered the “slave”. These different procedures will be discussed below in connection with FIG. 3 and FIG. 4.

The terms “master” and “slave” are used in the context of control system theory. For example, at any given moment, either the network management software (central server) or the VNM (facility server) is considered “master” of the configuration for a given VNM system. Whichever side is the master controls the specific procedure for synchronization as described below. By default, the network management software (central server) is designated as the master. The master-slave status for any given facility server can be changed by programming and/or through a user interface on the network management software.

Regardless of its own status, the network management software (central server) is responsible for tracking which server (central vs. facility) is the master, and for synchronizing the configuration information on the slave server to match that of the master server. The master-slave relationship applies to the central server 110 and each facility server separately, e.g., the central server 110 may be a master with respect to one facility server, but slave with respect to another facility server.

In one embodiment, the network management software on the central server 110 can determine which entity is the master by looking up server status information from a database, which may be stored on a memory device (not shown) internal or external to the central server 110.

In another embodiment, the state of a facility itself, e.g., operating state (as distinguished from the master-slave status with respect to the central server), is used to determine which server is the master. For example, if a facility is in a state of “NEW INSTALLATION,” then the central server 110 would automatically be the master server. If the facility is in a state of “LOCAL CONFIGURATION OVER-RIDE,” then the facility server will automatically be the master. If the facility is in a state of “NORMAL OPERATION,” then the central server 110 would automatically (e.g., by default) be the master. By assigning the master-slave status in accordance with the operating state of the facility, the master-slave status can be ascertained automatically by the central server, allowing the network system to operate in a more intelligent manner, e.g., without a need for real-time programming or human intervention.

If the central server 110 is the master, and the actual configuration information at a given facility differs from the information stored on the central server 110 (referred to as the “reference configuration information”), the central server 110 will push the reference configuration files or information to the facility server. This has the effect of forcing the facility server to stay in synchronization with the central server 110, i.e., the configuration information at the facility server will be replaced by the reference configuration information (associated with that facility server) from the central server.

Optionally, the difference between the configuration information can be reported to an appropriate entity or personnel, e.g., a network operator or staff, via e-mail, short message service (SMS), or routine report, including a web page, among others. The central server (or its network management software) can be configured to either synchronize and report the discrepancy, or to only report the discrepancy, or to only synchronize.

This is further illustrated in FIG. 3, which shows a method 300 of configuration synchronization to be implemented for a facility server if the central server is the master. The method can be implemented by the network management software on the central server.

In one embodiment, the method is performed using the REST API. Once it has been ascertained that the central server is the master with respect to a facility server (step 302), the configuration information or files stored on the central server for the specific facility is pushed to the VNM (facility server) of that facility, as shown in step 304, i.e., configuration information at the facility server is replaced by the reference configuration information from the central server.

In step 306, a trigger is provided to the VNM (facility server) to enter a maintenance mode. In step 308, a trigger is provided to the VNM (facility server) to reconfigure itself, and enter normal operations mode. As shown in step 310, a new MD5 sum is also computed for the new configuration of the VNM (facility server).

In step 312, a configuration check is performed to ascertain that the new configuration is indeed applied to the VNM (facility server). Such a configuration check may include, for example, one or more steps outlined in method 200 of FIG. 2. If the configuration check shows that the new configuration has not been applied to the facility server, then one or more of the previous steps 304, 306 and 308 can be repeated, or further remedial action can be requested.

In step 314, the time of the configuration check is recorded, e.g., stored to the database. Optionally, as shown in step 316, one or more messages or reports relating to the operation (e.g., configuration check, status, action taken, etc.) can be generated or sent to an appropriate entity or personnel, e.g., network operator or managing staff, using a variety of reporting mechanisms, including, for example, via a web page which can filter by site or time period.

If the facility server 102 is the master server with respect to the central server 110, a configuration procedure different from the above will be used. In this scenario, new configuration files will be pushed from the facility server 102 to the central server 110. This has the effect of forcing the central server 110 to stay in synchronization with the facility server 102, i.e., the reference configuration file (for facility server 102) stored on server 110 is updated or replaced by the configuration file from the facility server 102. Optionally, information relating to the difference in configuration information can be reported to an appropriate entity or personnel, e.g., via e-mail, short message service (SMS), or routine report, including by a web page, among others. The central server (or its network management software) can be configured to either synchronize and report the discrepancy, or to only report the discrepancy, or to only synchronize.

This is further illustrated in FIG. 4, showing a method 400 to be implemented when the facility server is the master. In one embodiment, method 400 is performed by the network management software using, for example, the REST API. After the master status of the facility server is ascertained by the central server (step 420), the configuration information or files for the VNM (facility server) are pulled from the facility server to the central server. As shown in step 404, the configuration information or files are stored on the central server, replacing the reference configuration files previously archived on the central server. These new reference configuration files become the latest archived versions of the files.

In step 406, the actual configuration information from the facility server, e.g., in the form of an MD5 sum, is written to the database on the central server, replacing the previously stored MD5 sum (i.e., reference MD5 sum). In step 408, the time of this configuration update is recorded to a database on (or accessible by) the central server 110. Optionally, in step 410, one or more messages or reports relating to the operation (e.g., configuration check, status, action taken, etc.) can be generated or sent to an appropriate entity or personnel using a variety of reporting mechanisms, including, for example, via a web page which can filter by site or time period.

In general, one or more steps in method 300 or method 400 may be performed by the network management software or another component associated with the central server, and certain steps may also be omitted or performed in a different order from those shown in FIG. 3 or FIG. 4.

The above examples of performing configuration synchronization are illustrative of various principles of the present invention, and one or more features discussed herein can be used singly or in combination with each other, or be adapted to suit other needs.

For example, instead of performing configuration check and synchronization for each facility site one at a time, different facility sites can also be grouped together according to various criteria or facility attributes, and configuration-related tasks can be performed for a particular site group. Aside from scheduled configuration checks, a user interface may be provided for performing configuration checks based on site groups, or for initiating on-demand configuration checks.

A user interface can also be provided for managing a group of facilities via a group management mode on the central server. This interface will allow a facility site to be allocated to different groups, and a user can also initiate configuration changes from the central server based on group membership.

While the forgoing is directed to various embodiments of the present invention, other and further embodiments of the invention may be devised without departing from the basic scope thereof. As such, the appropriate scope of the invention is to be determined according to the claims, which follow.

1. A method, comprising:
ascertaining whether a first configuration information from a first server at a facility is different from a second configuration information from a second server; and if so,
synchronizing the first configuration information and the second configuration information based on at least one of: a state of the facility, and a relationship between the first server and the second server;
wherein the first configuration information and the second configuration information relate to configuration of at least one device at the facility.

2. The method of claim 1, wherein the synchronizing step further comprising:
if the second server has a master status with respect to the first server, replacing the first configuration information on the first server by the second configuration information.

3. The method of claim 2, further comprising:
reconfiguring the first server in accordance with the second configuration information.

4. The method of claim 1, wherein the synchronizing step further comprising:
if the first server has a master status with respect to the second server, replacing the second configuration information on the second server by the first configuration information.

5. The method of claim 1, wherein the state of the facility relates to an operating state of the facility.

6. The method of claim 1, wherein the first server and the at least one device are components of an in-store advertising system.

7. The method of claim 1, wherein the first and second configuration information are provided in extensible markup language (XML) files.

8. The method of claim 7, wherein the synchronizing step further comprises:
if the second server has a master status with respect to the first server, replacing the first configuration information on the first server by the second configuration information; and
if the first server has a master status with respect to the second server, replacing the second configuration information on the second server by the first configuration information.

9. The method of claim 7, wherein the ascertaining step further comprises:
generating a first checksum value corresponding to the first configuration information on the first server;
generating a second checksum value corresponding to the second configuration information stored at the second server; and
comparing the first checksum value and the second checksum value.

10. The method of claim 9, wherein the first checksum and the second checksum are generated by using message digest algorithm 5 (MD5).

11. A system, comprising:
a first server connected to at least one device at a facility;
a second server at a location different from the facility;
the second server configured for synchronizing a first configuration information on the first server and a second configuration information on the second server based on one of: a state of the facility, and a relationship between the first server and the second server;
wherein the first configuration information and the second configuration information include information relating to the at least one device.

12. The system of claim 11, wherein the second server is further configured for replacing the first configuration information on the first server by the second configuration information from the second server if the second server has a master status with respect to the first server.

13. The system of claim 11, wherein the second server is further configured for replacing the second configuration information on the second server by the first configuration information from the first server if the first server has a master status with respect to the second server.

14. The system of claim 11, wherein the first server and the at least one device are components of an in-store advertising system.

15. The system of claim 11, wherein the first configuration information and the second configuration information are provided in extensible markup language (XML) files.
